(19) United States
(12) Patent Application Publication
(10) Pub. No.: US 2004/0214478 A1
(43) Pub. Date: Oct. 28, 2004

(54) Coupler-adapeter for electrical amd audio anatomical signal sensor

(75) Inventors: Martin Baumer, Carlton, OR (US); Peter M. Galen, Portland, OR (US); Steven A. Mahoney, McMinnville, OR (US); Jagtar S. Saroya, Washougal, WA (US)

Correspondence Address: Robert D. Varitz, ROBERT D. VARITZ, P.C., 2007 S.E. Grant Street, Portland, OR, 97214, US

(73) Assignee: Inovise Medical, Inc.

(21) Appl. No.: 10/424,537

(22) Filed: Apr. 24, 2003

(51) Int. Cl. H01R 4/48

(52) U.S. Cl. 439/729

(57) ABSTRACT

A coupler-adapter which is employable in an anatomical signal path that extends between an anatomical signal sensor, such as an ECG electrical sensor, including one which may also be designed to collect audio information, and external signal-reception structure. The couple-adapter includes body structure which may be directly connected to such a sensor, and which includes plural sensor reception regions that are configured to receive and accommodate, mechanically and electrically, plural different types of such sensors.

### BACKGROUND AND SUMMARY OF THE INVENTION

This invention relates to the collection and transmission for review of anatomical signals, such as anatomical electrical and audio signals. In particular, it relates to a unique coupler-adapter structure which is designed to receive and accommodate, both mechanically and electrically, different kinds of anatomical-signal sensor structures which may be selected for use in conjunction with collecting such signals. For the purpose of illustration herein, a preferred and best-mode embodiment of the invention is described and illustrated herein in relation to the collection and transmission of heart-produced signals, such as traditional ECG electrical signals and heart-produced audio signals. Of the specific types of sensors which are accommodated by the coupler-adapter of this invention, one is designed for the combined collection of both audio and electrical signals, and two others are designed just for the collection of electrical signals.

Those acquainted with the field of cardiology know that there are various kinds of sensors and electrode structures that are selectable for temporary attachment to different sites on the anatomy for the purpose of collecting anatomical signals such as those generally mentioned above. The present invention features a novel coupler-adapter structure which is designed to be capable, selectively, of receiving and accommodating, both mechanically and electrically, and essentially immediately adjacent the anatomical site where signal collection is to take place, several different kinds of anatomical signal sensors, such as electrode sensors which are designed principally to collect electrical signal, such as ECG signals, and also a relatively new kind of sensor which is designed to enable combined, common-anatomical-site collection of both audio and electrical signals.

In connection with mechanical accommodation of such various kinds of sensors, the coupler-adapter of this invention is designed with plural different docking stations, or reception regions, which are respectively designed for the releasably clamped reception and retention of a particular kind, or style, of sensor, and wherein a special “shared-activity” metallic spring component includes portions that are especially designed to furnish, in different ways, spring-biasing to the respective different clamping mechanisms that are employed for the different types of receivable sensors.

With regard to the electrical accommodation of a received sensor, this very same “shared activity” component is an electrically conductive member which plays a communicative role with regard to receiving, and carrying for outputting, electrical signals that are collected by the different receivable sensors. Additionally, the coupler-adapter of the invention is furnished with a housing including chamber space wherein electrical circuitry, including selected electrical circuit components, may easily be contained, and in a preferred embodiment of the invention, are contained, which circuitry functions to cooperate with the output transmission, to external monitoring apparatus, of electrical representations of signals collected by attached and accommodated sensors.

The coupler-adapter of this invention, designed as it is to be located essentially at the site where a sensor is to be employed on the anatomy, and equipped to receive and accommodate different kinds of selectable attachable sensors, provides a convenient and efficient coupling interface between external monitoring apparatus and different kinds of attachable sensors, and does so in a manner which minimizes, or eliminates, the need for various kinds of specialized retrofitting which might be required in order to adapt conventional monitoring apparatus to receive and deal with specific different kinds of anatomical sensors.

The various features and advantages which are offered successfully and conveniently by the coupler-adapter of the present invention will become more fully apparent as the description which now follows is read in conjunction with the accompanying drawings.

### DESCRIPTION OF THE DRAWINGS

FIGS. 1A, 2A, 3A present fragmentary, top, isometric views of a coupler-adapter constructed in accordance with a preferred embodiment, and best-mode implementation, of the present invention, with this coupler-adapter shown connected for use with (i.e. receiving and accommodating) three different kinds of anatomical signal sensors for which it has been designed.

FIGS. 1B, 2B, 3B present isolated, top, isometric views of the respective sensors that are shown connected to the coupler-adapter of this invention in FIGS. 1A, 2A, 3A, respectively.

FIG. 4, which is drawn on a somewhat larger scale than that which is employed in the first-mentioned drawing figures, provides a bottom plan view of the coupler-adapter of FIGS. 1A, 2A, 3A. At D₁ and D₂ in FIG. 4, certain relevant dimensions regarding two different operative conditions of a pair of opposed, relatively moveable, spring-biased clamping aims which are included in the coupler-adapter of this invention, and which are exposed on the underside of the coupler-adapter, are highlighted.

FIG. 5 is a same-scale side elevation taken generally along line 5-5 in FIG. 4. Dashed lines in FIG. 5 illustrate a special “shared-activity” component employed in the coupler-adapter of this invention.

FIGS. 6 and 7 are same-scale top-plan, and front-end, views, respectively, of the coupler-adapter of this invention, taken generally along lines 6-6 and 7-7 in FIG. 5.

FIG. 8, prepared on a larger drawing scale than that used in FIGS. 4-7, inclusive, is a clamping-feature-emphasized, bottom plan view of the coupler-adapter of this invention, similar in many ways to the view presented in FIG. 4. This figure specifically illustrates, in a somewhat isolated fashion, the mentioned, opposed, spring-biased clamping arms which are present in the proposed coupler-adapter, with these arms, in FIG. 8, illustrated in the conditions wherein the dimension labeled D₁ in FIG. 4 defines the nominal diameter of a generally circular clamping nip region which is defined between these arms, and which is referred to herein as a “smaller-diameter nip region”.

FIG. 9, which is drawn on substantially the same scale used in FIG. 8, is another clamping-feature-emphasized, bottom plan view of the coupler-adapter of this invention, similar in many ways to the view presented in FIG. 4. This figure specifically illustrates, in a somewhat isolated fashion, the mentioned, opposed, spring-biased clamping arms which are present in the proposed coupler-adapter, with these arms, in FIG. 9, illustrated in the conditions wherein the dimension labeled D₂ in FIG. 4 defines the nominal diameter of a generally circular clamping nip region which is defined between these arms, and which is referred to herein as a “larger-diameter nip region”.

FIGS. 10 and 11 are stylized, somewhat cross-sectional views taken generally along the line 10, 11-10, 11 in FIG. 4, with FIG. 10 isolating and showing a separation between the mentioned clamping arms that relates to dimension D₁ in FIG. 4, and with FIG. 11 isolating and showing a spacing between these same clamping arms relating to the dimension D₂ illustrated in FIG. 4.

FIGS. 12-14, inclusive, are fragmentary, isolating, cross-sectional views, taken generally from the same points of view presented in FIGS. 10 and 11, specifically showing the operation of reception, accommodation and clamping-in-place of an anatomical sensor of the type pictured in FIGS. 1A, 1B in the drawings. In FIG. 12 the entry end of this sensor is shown just being received between the slightly more widely spaced gripping portions of the mentioned clamping arms. In FIG. 13 a camming action, which effects drawing-in of this sensor, is pictured, with that camming action taking place between the clamping arms herein and a portion of the entry end of the pictured sensor. FIG. 14 illustrates full, clamped reception of this sensor by and between the clamping arms of the coupler-adapter of this invention.

FIGS. 15 and 16 are fragmentary plan and cross-sectional views, respectively, with FIG. 16 being drawn on a larger scale than that employed in FIG. 15. These two figures generally illustrate a sensor reception site, or region, in the coupler-adapter of this invention specifically designed to receive an electrode sensor like that which is pictured in FIGS. 2A, 2B.

FIGS. 17-19, inclusive, are fragmentary, cross-sectional views, very much like the view presented in FIG. 16, specifically illustrating the action of reception, clamped gripping, and mechanical and electrical accommodation, of the central snap-prong type electrode connector present in the sensor electrode structure that is pictured in FIGS. 2A, 2B.

FIGS. 20-22, inclusive, illustrate the structure and operation of an alligator-type reception site, or region, provided in the coupler-adapter of this invention for receiving and accommodating, in a clamped and held fashion, a long-strip electrode sensor like that pictured in FIGS. 3A, 3B.

FIG. 23 is an isolated, top, isometric view of what is referred to herein as a shared-activity, spring-biasing and electrically-conductive, path-contributing, common element, or component, that is included in the structure of the coupler-adapter of this invention. This is the same component referred to above as being shown by dashed lines in FIG. 5.

FIG. 24 is a stylized side elevation of the shared-activity component pictured in FIG. 23, taken from the point of view generally illustrated by line 24-24 in FIG. 23. This figure illustrates fragments of the three different kinds of anatomical-signal-collecting sensors that are pictured in FIGS. 1B, 2B, 3B, in relation to how the component of FIG. 23 co-acts with these sensors in both electrical and mechanical, shared-activity ways.

### DETAILED DESCRIPTION OF THE INVENTION

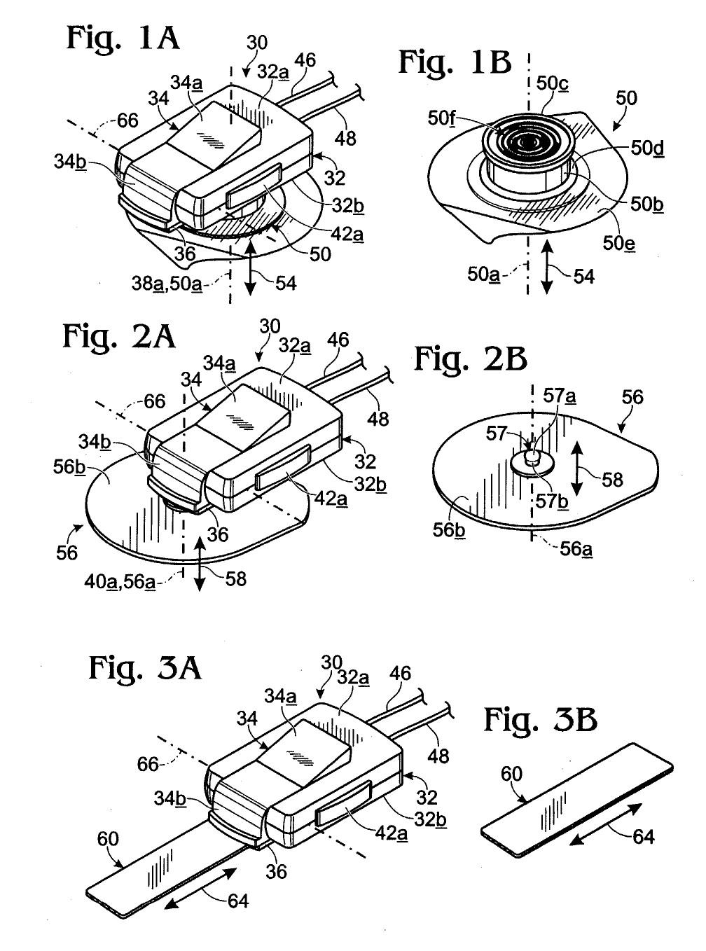

Turning now to the drawings, and referring first to FIGS. 1-11, inclusive, indicated generally at 30 is a coupler-adapter which is constructed in accordance with a preferred and best-mode embodiment of the invention. For the sake of word economy hereinafter, coupler-adapter 30 will most often be referred to simply as adapter 30, or as the adapter. An important feature of adapter 30, according to the invention, is that it is designed to receive and to accommodate, electrically and mechanically, plural, different types of anatomical signal sensors. This capability, and the structural componentry which enables it, will now be described and discussed.

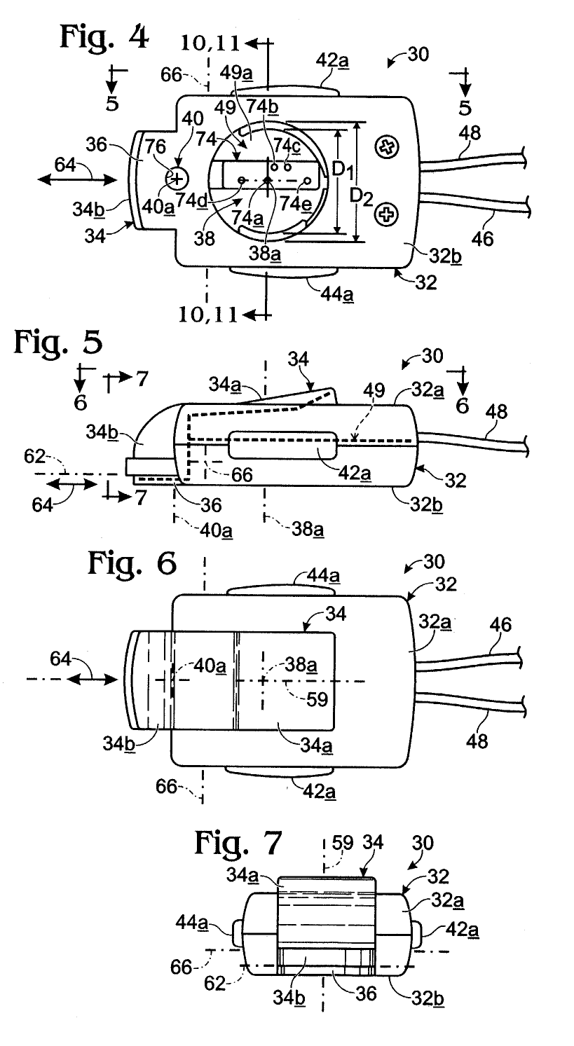

Included, inter alia, in adapter 30 are (a) a housing 32, having upper and lower faces 32a, 32b, respectively, (b) a rocker paddle 34 with a thumb(or finger)-engaging portion 34a and a nose portion 34b, (c) a forwardly projecting lip 36 on which nose portion 34a is shown seated (in FIGS. 1A, 2A and 5), (d) a pair of sensor reception sockets, or regions, 38, 40 which are exposed on lower housing face 32b (see especially FIG. 4), and (e) a pair of spaced, laterally exposed squeeze buttons 42a, 44a which are disposed on laterally opposite sides of housing 32. Lower housing face 32b defines the anatomy-facing “side” of adapter 30. Nose 34b is located at the front, or forward, end of the housing.

Shown fragmentarily, and extending from the rear end of adapter housing 32, are conductors 46, 48 which function to convey, to remote, external monitoring apparatus (not shown), electrical output signals that result ultimately from anatomical input signals that become collected by sensors coupled (connected) to the adapter.

Focusing attention for just a moment on FIG. 5, and including reference additionally to FIG. 23, shown generally at 49 is an electrically conductive, springy metal component which is suitably mounted within housing 32. This component functions herein importantly as what is called a shared-activity component that plays, as will be explained later herein, both spring-biasing roles, and electrical signal-conduction roles, with respect to attached sensors. Certain regions of, or portions within, component 49 play special roles, and these regions include a central, plate-like expanse 49a having a cut-out 49b, an L-shaped spring arm 49c which extends to one side of expanse 49a near cut-out 49b, a spring shelf 49d which extends into lip 36, and, as sub-portions of shelf 49d, a novel spiral-arm cantilever spring 49e with a “central”, end contact pad 49f, and three angular, punch-formed ramps 49g.

In FIG. 1A, adapter 30 is shown in a condition receiving and accommodating (i.e. connected to) a combined audio and electrical anatomical (heart) signal sensor 50, which is also pictured as an isolated structure in FIG. 1B. As will be explained shortly, adapter 30 and a sensor like sensor 50 are connectible and disconnectible, utilizing reception socket 38, along a socket axis which is shown at 38a, and also along what (during connection, use, and disconnection) is then a coinciding sensor axis 50a. Connection and disconnection sensor-relative-motion is suggested in the drawings by double-headed arrow 54 (Arrow 54 is also employed as a single-headed arrow in certain other drawing figures.)

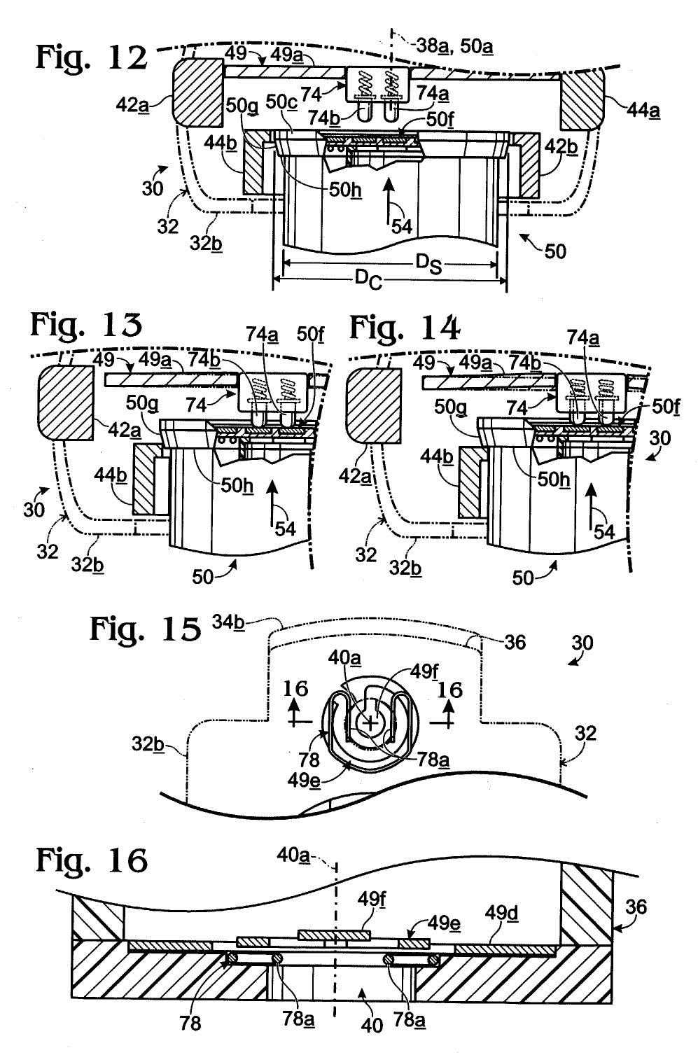

In general terms, combined audio and electrical sensor 50 includes a somewhat spool-of-thread-shaped body with an elongate, central, cylindrical portion 50b, a radially outwardly extending collar 50c and a radially outwardly extending skirt 50d formed at the upper and lower ends, respectively, of portion 50b, a flexible apron 50e, and a bull's eye pattern 50f of electrical conductors formed on the top of the sensor body. Cylindrical portion 50b has an outside diameter which is designated Dₛ herein (see FIG. 12). The undersides of skirt 50d and of apron 50e are coated appropriately with a conventional, sticky, electrically conductive hydrogel that functions to perform, among other things which will be discussed later, electrically conductive attachment to the anatomy. More will be said later about certain other structural features of this sensor.

In FIG. 2A, adapter 30 is shown in a condition receiving and accommodating (i.e. connected to) a conventional, somewhat circular-patch-type electrical-signal ECG sensor (electrode) 56, which is also pictured as an isolated structure in FIG. 2B. Sensor 56 includes a central snap-prong type mechanical and electrical connector 57. Adapter 30 and sensor 56 are connectible and disconnectible, utilizing reception socket 40 and connector 57, along a socket axis 40a, and also along that which becomes (during connection, use, and disconnection) a coinciding sensor axis 56a. Connection and disconnection sensor-relative-motion is suggested in the drawings here by double-headed arrow 58. As is true also for previously mentioned arrow 54, arrow 58 is employed in certain other drawing figures as a single-headed arrow. Axes 38a, 40a lie in a common plane 59 (see particularly FIGS. 6 and 7), which plane contains the longitudinal centerline (not specifically shown) of housing 32.

Sensor 56 includes a pliable, somewhat circular contact pad 56b which carries, centrally, previously mentioned elongate, electrically conductive, snap-prong connector 57, the underside of which, in FIGS. 2A, 2B, connects conductively with a sticky, electrically conductive substance (not shown), such as the hydrogel material mentioned earlier with respect to sensor 50.

Directing attention now FIG. 3A, here, adapter 30 is shown in an operative condition receiving and accommodating (i.e. connected to) a conventional, long-strip (rectangular) sensor electrode 60, the unseen underside of which carries a sticky, electrically conductive substance, such as the same hydrogel material mentioned above. Sensor 60 is illustrated as a free-standing structure in FIG. 3B.

Whereas sensors 50, 56 are connected for use in sockets 38, 40, respectively, sensor 60 is gripped in a spring-biased, alligator-grip fashion between rocker paddle nose portion 34b and lip 36. Insertion and retraction of this type of sensor, into and from the alligator-grip clamping region defined between components 34b, 36, takes place generally within a plane 62 (see especially FIGS. 5 and 7), and as is illustrated by double-headed arrow 64. Arrow 64, like earlier-discussed arrows 54, 58, also appears in certain other drawing figures as a single-headed arrow. This activity is accommodated by thumb(finger)-created rocking of rocker paddle 34 about an axis 66. Axis 66 extends as shown between the opposite lateral sides of housing 32, and is substantially parallel to plane 62. This axis also is substantially orthogonal with respect to previously mentioned plane 59.

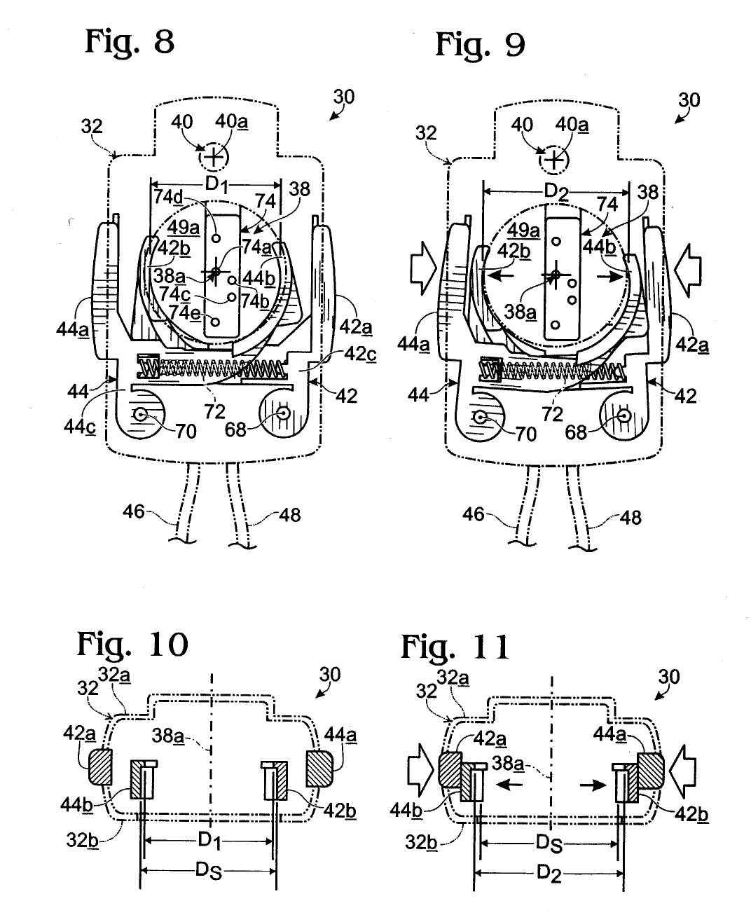

Substantially completing a description now of adapter 30, previously mentioned reception socket, or region 38, has a generally cylindrical configuration, as can be seen clearly in FIGS. 4, 8 and 9. With additional reference made now to FIGS. 12-14 in the drawings, one can see that laterally opposite sides of this generally cylindrical socket are somewhat defined by two, opposed, generally circularly curved (arcuate), relatively moveable clamping arms 42b, 44b which, along with previously mentioned squeeze buttons 42a, 44a, respectively, form component portions of two integrated, squeeze-button-operated clamping structures generally shown at 42, 44, respectively. (See especially FIGS. 8 and 9). Clamping arm 42a resides effectively on the opposite lateral side of housing 32 relative to the location of squeeze button 42a, and is joined to this squeeze button through an interconnecting base region 42c which is pivoted at 68 to appropriate other components in adapter 30. Similarly, arcuate clamping arm 44b resides on the opposite lateral side of housing 32 from its associated squeeze button 44a, and these two components are unified through a base region 44c which is pivoted appropriately at 70 on other components provided in adapter 30.

As can be seen especially well in FIGS. 4 and 8, the angular arcs subtended by clamping arms 42b, 44b are somewhat different. Very specifically, the arc subtended by arm 44b is greater than that subtended by arm 42b, and one of the reasons for this difference is to allow for base regions 42c, 44c, which extend overlappingly between these two arms, to enable a sufficient range of clamping-arm relative motion to accommodate convenient attachment and detachment of a sensor, like sensor 50.

Acting appropriately between clamping structures 42, 44 is a compression biasing spring 72 which urges the two clamping arms, and the two squeeze buttons associated with them, into the conditions and positions shown for them, respectively, in FIGS. 4, 8 and 10. In this condition of structures 42, 44, one can say that the confronting arcs of the two opposed clamping arms effectively define a generally circular nip region which has a nominal diameter that is shown at D₁ in FIGS. 4, 8 and 10. This nominal diameter D₁ is designed to be slightly smaller than the nominal outside diameter of cylindrical portion 50b in sensor 50, and the nip region which it defines is referred to herein as a smaller-diameter nip region. This nominal diameter for sensor portion 50b is shown in FIG. 12 at Dₛ.

When squeeze buttons 42a, 44a are squeezed inwardly, as is indicated by the two, opposing, broad arrows that are pictured in FIGS. 9 and 11, these squeeze buttons and their associated clamping arms rock appropriately, against resistance presented by basing spring 72, about axes 68, 70, and move toward the respective positions that are shown for them in FIGS. 9 and 11. Here, one will notice that the two clamping arms have separated somewhat, and specifically have separated enough that they now effectively define a somewhat larger-diameter nip region whose nominal diameter is represented in FIGS. 4, 9 and 11 at D₂. One will notice that diameter D₂ is slightly greater than previously mentioned sensor collar diameter Dₛ.

In FIGS. 8 and 9, dimension Dₛ is related to a dash-double-dot circle which is designated 50c, and which represents generally the “footprint” which sensor collar 50c casts upon the outline of adapter 30 during insertion, use, and retraction of sensor 50 with respect to socket 38. In FIGS. 8 and 9, this dash-double-dot representation of sensor collar 50c is centered on previously mentioned socket axis 38a.

Referring now especially to FIGS. 4, 8, 9, 12-14, inclusive, and 23, forming what can be thought of as the base of socket 38 are (a) the central region, or portion, 49a in component 49, and (b) an electrical pin-connector block 74 which is shown herein including five individually spring-biased, outwardly projecting pin connectors, or pins, 74a, 74b, 74c, 74d and 74e (see particularly FIG. 8). These several pins project into socket 38, and connect appropriately both (at least some of them) with previously mentioned conductors 46, 48, and also with any signal processing electrical circuitry (not specifically shown) which may be contained and provided within housing 32 in sensor 30. At least one of these pins connects conductively at an appropriate location, such as at the location of a tab 49h in component 49 (see FIG. 23) with shared-activity component 49. Under normal circumstances when no sensor, such as sensor 50, is received in socket 38, the projecting pins that extend from pin block 74 extend into socket 38 as illustrated in FIG. 12 in the drawings.

Describing now just a bit more about sensor 50, before proceeding with an operational description of adapter 30 regarding each of the different types of sensors illustrated and discussed herein, included on the underside (the anatomy-facing side) of sensor 50, as such is pictured in FIG. 1B, is an exposed cavity (not shown) which is employed to collect audio signals, and to make these signals available to an appropriate audio transducer, such as a microphone, which is appropriately provided in sensor 50. Inside the main body of sensor 50 is certain electrical circuitry which is capable of performing various signal management functions with respect to the gathering by sensor 50 of both electrical and audio signals. This circuitry connects appropriately with different ones of the conductive traces that form previously mentioned bull's eye pattern of conductors 50f on the upper side of the main body in sensor 50.

Pins 74a-74e, inclusive, herein are appropriately positioned within the confines of socket 38, whereby they may each come into contact with a different one of the various conductive traces furnished in conductor pattern 50f.

Finally, and directing attention specifically to FIG. 12, sensor collar 50c, on and along the lower region thereof as such is pictured in FIG. 12, includes an inwardly angled camming surface 50g which terminates with a downwardly facing shoulder 50i that extends radially outwardly a small distance from the outside diameter Dₛ of sensor cylindrical portion 50b.

When it is desired to connect sensor 50 to adapter 30 at the location of socket 38, squeeze buttons 42a, 44a, are squeezed toward one another against the action of biasing spring 72. This action places clamping aims 42a, 42b generally in the positions shown for them in FIG. 9. In this condition of these clamping arms, the larger-diameter, generally circular nip region defined between them is large enough to permit the diameter of collar 50c to pass inwardly beyond the arms and into socket 38. Initial entry of collar 50c between the thus spaced clamping arms is shown generally in FIG. 12.

With continued inward slight movement of sensor 50, and with relaxation of squeeze pressure on buttons 42a, 44a, the closest opposing surfaces in clamping arms 42b, 44b come into edge contact with camming surface 50g, and this situation is illustrated clearly in FIG. 13.

If one now simply completely releases the squeeze buttons, biasing spring 72 drives the clamping arms toward the positions shown for them in FIG. 8, and because of the engagement just previously described between these clamping arms and camming surface 50g, such inward spring-biased driving action functions to draw sensor 50 inwardly along axes 38a, 50a into socket 38. Very specifically, the sensor is drawn into socket 38 to a point where the clamping arms can snap inwardly under the influence of spring 72 to produce a kind of positive anti-retraction lock by engagement with collar shoulder 50h. This condition is illustrated in FIG. 14.

Under circumstances with camming action taking place, as is illustrated in FIG. 13, sensor 50 will have entered socket 38 far enough to create engagements between the projecting pins in block 74 and the conductive traces in conductor pattern 50f. Such engagement causes the pins to shift inwardly into block 74 against the respective biasing of their biasing springs, and this can be seen to be taking place in FIG. 13. There is thus a situation now where electrical contact is made between the conductive traces in pattern 50f and the buttons projecting from block 74. Additionally, a mechanical biasing action begins to occur, whereby the pins that project from block 74 exert a downward, or outwardly axially rejecting, force against the entry end of sensor 50. With block 74 anchored to the central portion 49a of shared-activity component 49, a slight springy deflection takes place in component portion 49a, and this is suggested by comparing the dash-double-dot and solid outline conditions illustrated in FIGS. 13 and 14 for this central portion of component 49.

Accordingly, component 49, cooperating with the biasing springs that are provided for the projecting pins in block 74, and also cooperating with these pins themselves, urges the sensor axially in a manner wherein, when the state of affairs pictured in FIG. 14 is achieved, these cooperating biasing structures serve to urge the sensor, and very specifically shoulder 50h, against the clamping arms to help to engage, hold and stabilize sensor 50 with respect to adapter 30. It is with respect to this biasing activity which has just been described that component 49 plays a role in mechanical spring-biasing with respect to an attached condition existing between adapter 30 and a sensor like sensor 50. In addition, because at least one of the pins which projects from block 74 makes contact with one of the electrical traces on the entry end of sensor 50, and because this pin is one which is electrically connected to component 49, a signal-management electrical flow path is created wherein component 49 plays a signal-communication role in the operation of an attached sensor 50.

When it is desired to decouple sensor 50 from adapter 30, this is done very simply by once again squeezing inwardly on the squeeze buttons thus to open up the spacing between the clamping aims, and then drawing outwardly on sensor 50 to disconnect it.

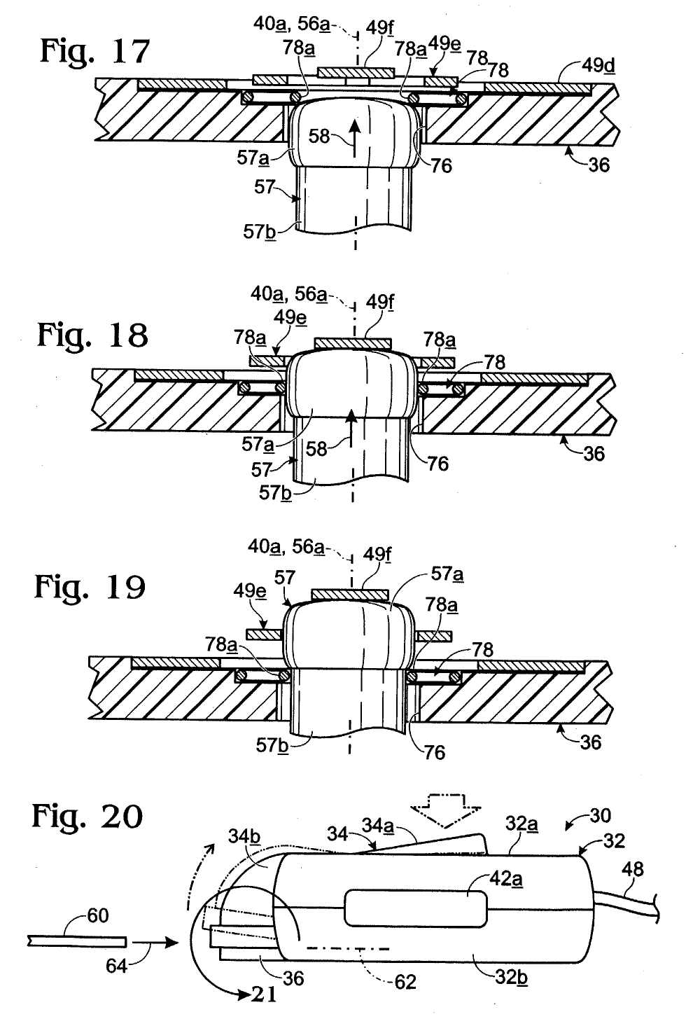

Turning attention now to how adapter 30 works in conjunction with a sensor electrode like sensor electrode 56, this activity is best understood and described in relation to FIGS. 4, 5-19, inclusive, and 23. An appropriate throughbore 76 effectively defines a cylindrical through passage that forms at least a part of previously mentioned socket 40. Looking through this passage along axis 40a, one is able to see therein spiral cantilever arm element 49e, with end pad 49f being disposed substantially directly centered on this axis. Appropriately mounted in the vicinity of socket 40 is a bent-wire spring clip which is clearly illustrated at 78 in FIG. 15. This spring clip is also shown in section in FIGS. 16-29, inclusive. Included in spring clip 78 are two, opposed, elongate and generally parallel end legs 78a that are disposed effectively toward opposite lateral sides of cantilever spring-element pad 49f. This relationship can be seen clearly in FIG. 15.

As will now be explained, cantilever spring element 49e and spring clip 78 play cooperative roles in spring-biased capture and holding of a sensor snap-prong, such as snap-prong 57 in sensor 56. With respect to this kind of a snap-prong, and looking for a moment specifically at FIGS. 2B and 17-19, inclusive, one will see that the snap-prong has an enlarged diameter head 57a which joins with a somewhat smaller diameter stem 57b that extends from the head toward the main body of the sensor.

To attach sensor 56 to adapter 30, snap-prong 57 is inserted into throughbore 76 as illustrated in FIG. 7 to drive against legs 78a in spring clip 78. A certain predetermined amount of force is required to cause legs 78a to separate sufficiently to allow further passage of the snap-prong, and in FIG. 18, one sees a condition where the enlarged head in the snap-prong has entered the space between these two spring-clip legs. As can also be seen in FIG. 18, it is at about this condition of insertion of snap-prong 57 that the outer end of head 57a engages central pad 49f in the spiral cantilever spring arm 49e.

With continued inward progression of the snap-prong, a fully inserted condition, like that pictured in FIG. 19, is achieved, whereupon legs 78a are now pressed against the outside surface of snap-prong stem 56b, beneath enlarged head 57a, and with the outer end of head 57a now having deflected pad 49f to a greater extent than that which is illustrated in FIG. 18.

It is important to note at this juncture, that the axial, spring-biasing force which holds contact pad 49f against the outer end of snap-prong head 57a, while large enough to create an effective electrical connection between these two components, and also while large enough to assist in urging the enlarged head of the snap-prong downwardly against spring-clip legs 78a, that the axial force thus exerted on the snap-prong not be large enough to drive the snap-prong outwardly of its seated condition in relation to legs 78a. In other words, the force required to disengage sensor 56 from adapter 52 must be greater than the force which is exerted by contact pad 49f on prong-head 57a.

One will further observe that spring force now exerted through contact pad 49f on snap-prong 57 is also contributed to by a certain amount of deflection in portions of component 49 which are immediately adjacent spiral cantilever spring-arm 49e. Thus one can see that, in relation to sensor 56 also, shared-activity component 49 participates both in mechanical biasing action that helps to stabilize an attached sensor, like sensor 56, and also furnishes an electrical-signal conduction path for signals acquired by sensor 56.

Removal of sensor 56 is accomplished simply by pulling it away from adapter 30 with sufficient force to cause enlarged snap-prong head 57a to pass again through and between legs 78a by separating these legs sufficiently.

With reference now to FIGS. 3A, 3B, 5-7, inclusive, and 20-23, inclusive, an elongate strip sensor, such as sensor 60 is attached to adapter 30 by pressing downwardly on paddle portion 34a in paddle 34 to rock this paddle to the condition generally shown for it in dash-double-dot lines in FIGS. 20-22, inclusive. This action produces rocking of the rocker paddle about previously mentioned axis 66, and causes an alligator-grip opening to become exposed between paddle nose 34b and lip 36.

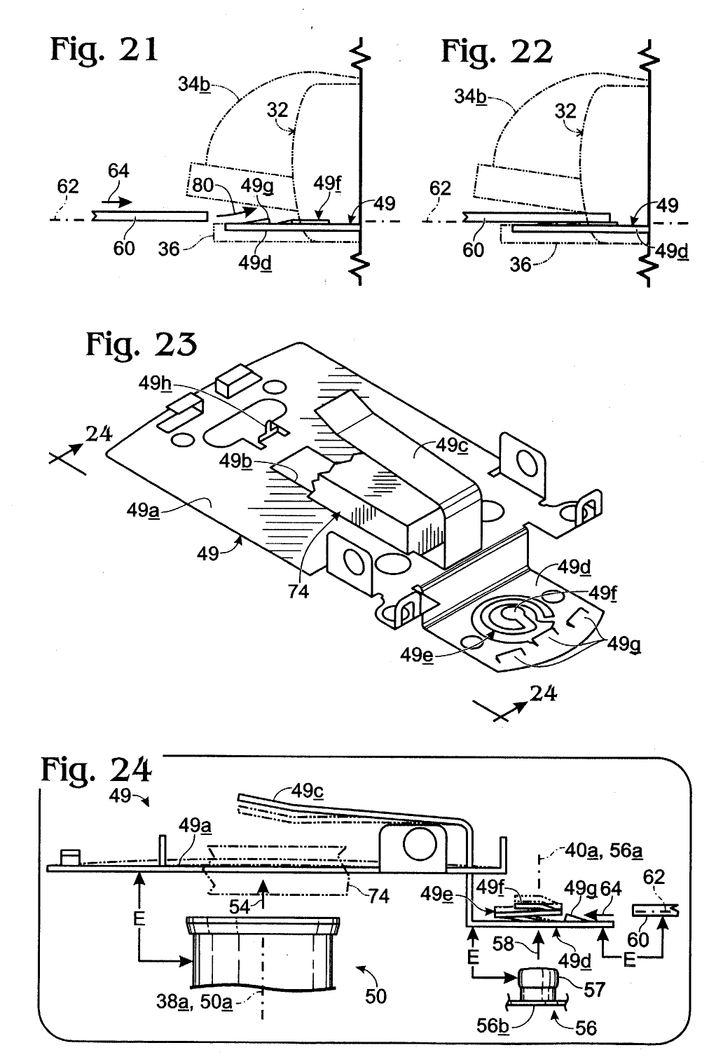

Exposed now on that side of lip 36 which faces nose 34b is shelf portion 49d in component 49. Sensor 60 is now simply inserted into this region, as indicated by arrow 64, and within plane 62, with ramps 49g, as is generally illustrated by a slightly curved arrow 80 in FIG. 21, defectively guiding the entering end of sensor 60 into this region in a manner which causes it to pass over slightly projecting spiral arm pad 49f. In other words, ramps 49g guide the entering end of sensor 60 in a manner which causes the end to clear, rather than to become snagged by, any part of spiral spring arm 49e.

As was previously mentioned, rocker paddle 34 is spring-biased by spring arm 49c in component 49, and with sensor 60 fully inserted into the alligator-grip region just described, simple by letting go of paddle 34, spring arm 49c causes the alligator-grip region to close down on the inserted sensor, thus to create a clamped retention mechanically for this sensor, and also to establish a firm, spring-biased, electrical connection with shelf 49d in component 49.

Here, too, one can see that shared-activity element plays both a mechanical and an electrical role with respect to spring-biased reception and holding of a sensor, like sensor 60, as well as electrical signal conduction regarding any electrical signal collected by sensor 60.

To decouple sensor 60 from adapter 30, the rocker paddle is again manipulated to open up the alligator-grip region just discussed, and the previously connected and clamped sensor 60 is simply withdrawn and removed.

Turning attention now to FIG. 24 in the drawings, here, in stylized and fragmentary side outline form, the shared-activity behavior which has been described hereinabove regarding how component 49 behaves with each of the three different types of sensors illustrated herein is clearly shown. In solid outline form, component 49 is shown in a condition not supplying any spring-biasing or electrical connection support for an attached sensor. In dash-double-dot outline form, three different deflected regions of component 49 are illustrated to highlight behavior of this component as a spring-biasing element which participates in the connection of all three sensors.

Extending between each of the fragmentary showings of sensors 50, 56 and 62 in FIG. 24, and associated by a pair of arrows, is the capital letter “E”. This representation in FIG. 24 is employed simply to confirm that, when each particular sensor is connected for use, an electrical connection is established appropriately between portions of that sensor and conductive component 49.

There has thus been described herein, a unique coupler/adapter designed for the reception and accommodation, mechanically and electrically, of three very different kinds of anatomical signal sensors. Each accommodated sensor, when connected to the coupler-adapter, is held and stabilized in place through an appropriate clamping action, which action, in the case of each type of sensor, is due in part to a contribution from a shared-activity component, which also then functions as part of an electrical signal conduction path provided for the connected sensor. With regard to a sensor which is like sensor 50, the novel, associated socket and opposed spring-biased clamping mechanism proposed herein uniquely utilizes a camming action, during attachment, to draw the attaching end of the sensor into a seated and locked condition within the socket. Spring-biased electrical connection pins, supported ultimately through a central region of shared-activity component 49, participate in mechanical biasing and positional stabilization of an attached sensor like sensor 50.

Those skilled in the art will recognize that, while a preferred embodiment of the invention has been described herein, variations and modifications are possible, and may be made without departing from the spirit of the invention.

We claim:

1. A coupler-adapter employable in an anatomical signal path which extends between (a) an anatomical signal sensor structure designed to be positioned to perform signal collection from adjacent a selected anatomical site, and to furnish electrical-signal output based on such collection activity, and (b) selected, external signal-reception structure, said coupler-adapter comprising
body structure placeable adjacent such a site, and
plural reception regions formed in and with respect to said body structure, each configured for the independent, selective, detachable reception of an individual anatomical signal sensor structure, and each including electrical signal-flow structure adapted to receive electrical-signal output furnished by a received signal sensor structure.

2. The coupler-adapter of claim 1 which is designed to cooperate with plural, structurally differentiated, anatomical signal sensor structures, and each said reception region is specifically configured for the detachable reception of a single, particular, different style of such a sensor structure.

3. The coupler-adapter of claim 2, wherein there are three reception regions, each formed to receive a different style of three differently configured sensor strictures.

4. The coupler-adapter of claim 2, wherein, operatively associated with each reception region is a spring-biased clamping structure which assists in the detachable reception of a signal sensor with respect to that region.

5. The coupler-adapter of claim 4, wherein each said clamping structure, in relation to the associated reception region, includes electrically conductive sub-structure which forms part of the electrical signal-flow structure that is associated with that region.

6. The coupler-adapter of claim 1, wherein, operatively associated with each reception region is a spring-biased clamping structure which assists in the detachable reception of a signal sensor with respect to that region.

7. The coupler-adapter of claim 6, wherein each said clamping structure, in relation to the associated reception region, includes electrically conductive sub-structure which forms part of the electrical signal-flow structure that is associated with that region.

8. The coupler-adapter of claim 6 which further includes, within said body structure, a shared-activity spring component which includes plural, different spring portions each of which contributes to the respective spring-biasing activity which is associated with a different reception region.

9. The coupler-adapter of claim 8, wherein each of said spring portions is electrically conductive, and forms part of the electrical signal-flow structure for the associated reception region.

10. The coupler-adapter of claim 9, wherein said spring portions, under all circumstances, possess a common electrical potential.

11. The coupler-adapter of claim 8, wherein one of said reception regions is adapted to receive an anatomical signal sensor structure of a style including a single-prong-type electrical connection component, and the spring biasing mechanism which is associated with this said one region includes a spiral cantilever spring arm which forms part of said shared-activity spring component, said spring arm being disposed in the coupler-adapter to be engaged and loaded into a condition of spring reaction by the prong in such a sensor when the sensor is received by the subject reception region.

12. The coupler-adapter of claim 1, wherein (a) one of said reception regions is defined by a socket/well which is formed in said body structure, with said socket/well being at least partially defined by a pair of opposed, relatively movable clamping arms, (b) another one of said regions takes the form of another socket/well formed in said body structure, the base of which second-mentioned socket/well is at least partially defined by the free end of a spiral cantilever spring arm, and (c) a third reception region is defined as an alligator-clip-type region including spring-biased, opposed and relatively movable jaws.

13. The coupler-adapter of claim 12 which further includes circuit structure disposed within said body structure adapted to play a signal conveyance role with respect to electrical-signal output which is furnished by a signal sensor structure which is received in any one of said reception regions.

14. A signal-communicating coupler-adapter for receiving a detachably connectible, plural-parameter, anatomical-signal sensor adapted to collect anatomical signals, and to produce therefrom related electrical output signals, said coupler-adapter comprising
body structure, and
a mechanico-electric reception docking site including mechanico-electric releasable clamping structure configured releasably to receive and hold such a sensor, and to convey away from a received sensor electrical output signals produced thereby.

15. The coupler-adapter of claim 14, wherein said reception docking site takes the form of a cylindrical well-like structure which includes sidewall regions that are at least partially defined by a pair of opposed, relatively moveable clamping arms.

16. A signal-communicating coupler-adapter for receiving a detachably connectible, plural-parameter, anatomical-signal sensor adapted to collect anatomical signals, and to produce therefrom related electrical output signals, said coupler-adapter comprising
body structure, and
plural mechanico-electric reception docking sites each at least partially defined by mechanico-electric clamping structure which includes electrically conductive sub-structure that is electrically common to the clamping structures associated respectively with each other docking site, each said clamping structure being configured releasably to receive and hold such a sensor, and to convey away from a received sensor electrical output signals produced thereby.

17. The coupler-adapter of claim 16, wherein one of said reception docking sites takes the form generally of a cylindrical well-like structure which includes sidewall regions that are at least partially defined by a pair of opposed, relatively moveable clamping arms which form part of the mechanico-electric clamping structure associated with that site.
